(19) United States
(12) Patent Application Publication
(10) Pub. No.: US 2012/0201601 A1
(43) Pub. Date: Aug. 9, 2012

(54) SANDWICH WEDGE CLAMP FOR FASTENING A SOLAR PANEL

(75) Inventor: Nathan Rizzo, Williamsville, NY (US)

(73) Assignee: Solar Liberty Energy Systems, Inc., Williamsville, NY (US)

(21) Appl. No.: 13/369,755

(22) Filed: Feb. 9, 2012

Related U.S. Application Data
(60) Provisional application No. 61/462,898, filed on Feb. 9, 2011.

(51) Int. Cl. F16B 2/14; B23P 11/00

(52) U.S. Cl. 403/409.1; 29/428

(57) ABSTRACT

The present invention includes a solar panel mount. The solar panel mount comprises a mounting surface such as a base or a rail. The rail has a generally elongated clamp plate attached to the rail proximal to a first end and having a clamp pad proximal to a second end. There is a wedge plate pivotally connected to the rail proximal to a first end of the wedge plate. The wedge plate is attached between the rail and the generally elongated clamp plate. The wedge plate is pivotal from a disengaged position to a clamping position. The clamping position is the position of the wedge where the wedge head is between the clamp plate and the rail. In another embodiment, the mount is configured to support a solar panel having a flange that is clamped between the clamp pad and the rail.

### CROSS-REFERENCE TO RELATED APPLICATIONS

This application claims the benefit of U.S. Provisional Application No. 61/462,898 filed Feb. 9, 2011, which application is incorporated by reference in its entirety herein.

### BACKGROUND OF THE INVENTION

1. Field of Invention

This invention relates generally to systems for mounting solar panels (such as photovoltaic cells) or other framed objects on a rail and more specifically to roof mounted racking systems for mounting framed photovoltaic cells.

2. Discussion of Related Art

Solar energy provides the opportunity to generate electricity without consumption of fossil fuels and is considered clean technology. In recent years, the development of technology for solar thermal systems and photovoltaic systems has improved the overall viability of solar energy. Thus, the demand for solar energy has increased.

The cost of solar panel technology includes a significant investment in installation of the equipment. Thus, a technology advance that reduces the cost of installation makes this clean technology more viable and attractive from an investment perspective.

The quality of installation also affects the efficiency of solar panel installation. The direction of the solar panels relative to the sun, the angle of the solar panels relative to the horizon, the density of solar panels in a given area, as well as position of solar panels relative to other panels can have a positive or negative effect on performance of the solar powered system. Such considerations are of great importance when assembling a solar panel system on a flat roof with limited area. The ability to assemble with one additional row of solar panels without causing overlap of the solar panels in sunlight or compromising optimal positioning would be a great advantage. Moreover, it would be advantageous if panels and their support structures could be assembled to provide easy installation, reduced shipping cost and function effectively.

Additionally, prior art solar panel mounting systems have been known to require periodic maintenance after installation to ensure that vibrations from the wind do not over time loosen fasteners such as nuts and bolts. Thus, it would be advantageous for a system to not be vulnerable to loosening or weakening over time to the degree that periodic maintenance is required. Because, solar panels are now being manufactured for fifteen, twenty and even twenty-five year lives, it is desirable for solar panel mounting systems to not require tightening of the fasteners over period equal to or greater than the life of the panels.

The ease of installation can be improved by systems for supporting solar panels that can be assembled without jigs and assembly tools. However, such systems can create disadvantages. For example, a system that is easy to assemble is often potentially easy to dissemble, subjecting the ballasted system to risk of theft. Additionally, a tool-less system needs to be sufficiently robust to withstand years of weather and outdoor wear. Thus, it would be desirable and advantageous to have an installation system that is easy to assemble (without tools or jigs), but difficult to dissemble and sufficiently robust that it can be expected to withstand years of outdoor weather and wear in sometimes harsh environments. It would also be advantageous if the clamping mechanism was concealed from view by the solar panels to improve aesthetics and to further make dissembling the device more difficult—thereby deterring theft of the panels.

The present invention addresses these and other needs.

### SUMMARY OF THE INVENTION

In one embodiment, there is a solar panel mount. The solar panel mount comprises a rail, preferably an elevated rail. The rail has a generally elongated clamp plate attached to the rail proximal to a first end and having a clamp pad proximal to a second end. There is a wedge plate pivotally connected to the rail proximal to a first end of the wedge plate. The wedge plate is attached between the rail and the generally elongated clamp plate. The wedge plate is pivotal from a disengaged position to a clamping position. The clamping position is the position of the wedge where the wedge head is between the clamp plate and the rail. In another embodiment, the mount is configured to support a solar panel having a flange that is clamped between the clamp pad and the rail.

In one embodiment, there is a method of mounting a solar panel, comprising the step of providing a solar panel of the type having a frame around the solar panel and a flange on the frame beneath the solar panel. One or more solar panel mounts (preferably two mounts per rail) are provided. The solar panel mounts are set forth according to one or more embodiments of the present invention. The flange of the clamp is placed between the clamp plate and the rail. The wedge plate is moved from a disengaged position to a clamping position. When the wedge plate is moved into clamping position, a clamping force is created between the clamp plate and the rail that is sufficiently strong to hold the solar panel on the rail. The clamp does not substantially fatigue over long periods of time. Thus, the clamp is believed to effectively hold the panels in place for several years without the need for tightening the bolts on the panel, as is often needed in prior art mounting systems.

In yet another embodiment, the clamp plate and the wedge plate are slidably attached to rail by at least one pin that is slidable within a channel in the rail. Depending upon the length of the channel, the channel allows movement of the clamp mechanism along the rail to facilitate in one embodiment, the use of the solar panel mounting system with solar panels of varying sizes. However, because use of a single rail for different sizes of solar panels potentially creates less than optimal solar panel layout, the channels are useful to allow adjustments in the position of the panels responsive to mounting the system on uneven surfaces, such as roofs.

In one embodiment, there is a method of mounting a solar panel, comprising the step of providing a solar panel of the type having a frame around the solar panel and a flange on the frame beneath the solar panel. One or more solar panel mounts are provided comprising rails and clamping mechanisms described above. The clamping mechanisms are slidably attached to channels in the rail. Preferably two clamping mechanisms per rail are provided. The solar panel mounts are set forth according to one or more embodiments of the present invention. The flange of the clamp is placed between the clamp plate and the rail. The wedge plate is moved from a disengaged position to a clamping position.

In still another embodiment, the clamp plate is generally bow shaped defining an apex having a predetermined height between the first end of the clamp plate and the clamp pad. The apex is defined as the portion of the clamp plate that is farthest away from the rail due to the bow shape. The clamp plate is affixed proximal the first end by a first pin and a second pin proximal the apex. By proximal it is meant close in proximity relative to the size of the overall object and the identified position relative to various features of the object. Thus, in one embodiment, proximal one end of an elongated object would mean within the first 25 percent of the length or perhaps within the first ten percent of the length in another embodiment. Proximal one end of an object, for example would mean near the one end and before any additional defined physical features of the object.

The distance between the clamp plate and the clamp pad is determined by the thickness of the lip, flange or plate that is to be secured and the thickness of the wedge plate. The distance between the clamp plate and the clamp pad is less than the sum of these two thicknesses by an amount that will cause the clamp plate to flex with sufficient force to hold the lip, flange or plate securely in place. In one embodiment the distance is less than 3 mm, preferably less than 2 mm. More preferably less than one MM.

The bow shape describe above adds flexural strength that presses the clamp plate against the solar panel under tension. Thus, over long-term wear of the object under normal operating conditions, the clamp will not loosen its hold on the solar panel. Advantageously, the clamp plate is capable of holding the frame in position and retains sufficient flexural strength for more than ten years, preferably more than 15 years, most preferably more than 25 years without requiring tightening of fasteners or replacement of parts.

In one embodiment, the effective length of the first pin and second pin as well as the apex height are predetermined to create a distance between the clamp plate and the rail that is less than the thickness of the wedge plate.

In another embodiment, the first pin and second pin are rivets. Rivets are advantageous because the effective length of the rivets can be set during manufacturing and can never be tampered with or adjusted. Thus, careful manufacturing tolerances and quality control can result in a product line where the clamp force is not too tight that the wedge plate cannot be moved into clamping position manually (i.e. without the use of a tool such as pliers, screwdrivers, levers or hammers). However, when the wedge plate is positioned in a clamping position, the clamp force is sufficiently strong to securely hold the panel in place.

In still another embodiment, the wedge plate has a bevel edge on the side that engages the rail and a thumb pad on the opposite side of the rail. The thumb pad functions to provide a more comfortable surface against which the wedge plate can be moved into a clamping position from a disengaged position.

It can be recognized, by a person of ordinary skill in the art that the present invention can be adapted to mount a number of generally flat object to a supporting surface—particularly generally flat framed objects. In one embodiment the present invention includes an object mount—preferably a framed object mount. The framed object mount comprises a substrate surface. To the substrate surface is attached a clamping mechanism. The clamping mechanism comprises a generally elongated clamp plate attached to the support surface proximal to a first end and having a clamp pad proximal to a second end. The mechanism has a wedge plate pivotally connected to the supporting surface proximal to a first end of the wedge plate and a wedge head distal to the first end. The wedge plate is pivotal from a disengaged position to a clamping position. In the clamping position, the wedge head is between the clamp plate and the supporting surface.

In one embodiment, there is a method of mounting a framed object. The method comprises providing a framed object of the type having a frame around the framed object and a flange on the frame beneath the framed object. The method further comprises providing a supporting surface and a clamping mechanism according to one or more embodiments disclosed herein. The method comprises placing the flange of the framed object between the clamp plate and the support surface. The wedge plate is moved from the disengaged position to the clamping position. In the clamped position the framed object is secured to the supporting surface.

In one embodiment, the object mount is configured to support a framed object having a flange that is clamped between the clamp pad and the supporting surface.

In another embodiment, the clamp plate and the wedge plate are slidably attached to the support surface by at least one pin that is slidable within a channel in the supporting surface. The method of mounting an object further includes sliding the clamping mechanism according to one or more embodiments along the channel to engage the object by positioning the object, the frame of the object or the flange of the frame under the clamp plate. The wedge plate is moved from the disengaged position to the clamping position.

In an embodiment, the clamp plate is generally bow shaped defining an apex having a predetermined height between the first end of the clamp plate and the clamp pad, the clamp plate is affixed to the supporting surface proximal the first end by a first pin and a second pin proximal the apex.

In another embodiment, the effective length of the first pin and second pin as well as the apex height are predetermined to create a distance between the clamp plate and the supporting surface that is less than the thickness of the wedge plate.

In another embodiment, the wedge plate has a bevel edge on the side that engages the support surface and a thumb pad on the opposite side of the wedge plate.

In still another embodiment, wherein the distance between the clamp plate and the support surface creates a clamping force that enables the wedge plate to be pivoted into the clamping position manually, but is sufficiently strong to secure the plate to the support surface.

In one embodiment, there is a solar panel mount that comprises a base plate to which the solar panel can be mounted. The base plate in one embodiment is a bottom clamp plate. In another embodiment, it is a rail to which the solar panel is designed to be mounted. The solar panel mount further includes a generally elongated clamp plate attached to the base plate proximal to a first end and having a clamp pad proximal to a second end. The mount further includes a wedge plate moveably connected to the base plate between the base plate and the generally elongated clamp plate. The wedge plate is movable from a first disengaged position to a second clamping position. The clamping position clamps the solar panel between the clamp plate and the base plate.

In one embodiment, there is a mount that is configured to support a solar panel having a clamp receiving flange that is clamped between the clamp pad and the base plate.

In one embodiment, the base plate is a rail and the clamp plate and the wedge plate are slidably attached to rail by at least one pin that is slidable within a channel in the rail.

In another embodiment, the base plate is generally bow shaped defining an apex having a predetermined height between the first end of the base plate and the second end of the base plate.

In still another embodiment, the clamp plate is generally bow shaped defining an apex having a predetermined height between the first end of the clamp plate and the clamp pad. The clamp plate is affixed proximal the first end by a first pin and a second pin proximal the apex.

### BRIEF DESCRIPTION OF THE DRAWINGS

FIG. 1 is an overhead view of a solar panel in a frame with the solar panel partially cut away to show the clamping mechanism of one embodiment of the present invention.

FIG. 2 is an enlarged view of the clamping mechanism shown in circle A of FIG. 1.

FIG. 3 is an enlarged elevated side view of the clamping mechanism of FIG. 1 taken along the lines of 3-3.

FIG. 4A is a side view of the wedge plate of one embodiment of the present invention.

FIG. 4B is a front view of the wedge plate of FIG. 4A taken along the lines of 4A-4A.

FIG. 5 is an elevated view of a rail and a pair of clamping mechanisms according to one embodiment of the present invention.

FIG. 6 is an enlarged view of the rail of FIG. 5 taken from circle C.

FIG. 7 is an enlarged view of the rail of FIG. 5 taken from circle D.

FIG. 8 is a rail and pair of clamping mechanisms of one embodiment of the present invention.

FIG. 9 is an enlarged view of the rail of FIG. 8 taken from circle E.

FIG. 10 is an enlarged view of the rail of FIG. 9 taken from circle F.

FIG. 11A is a side view of a wedge clamp of FIGS. 5-7.

FIG. 11B is a front view of a wedge clamp of FIGS. 5-7.

FIG. 12A is a side view of an alternative wedge clamp compatible with the system of FIGS. 5-7.

FIG. 12B is a front view of an alternative wedge clamp compatible with the system FIGS. 5-7.

FIG. 13 is a perspective view of an embodiment of the clamp mechanism of the present invention.

FIG. 14 is a perspective view of clamp mechanism of FIG. 13 with the two parts separated.

FIG. 15 is a side view of the clamp mechanism of FIG. 14.

### DETAILED DESCRIPTION

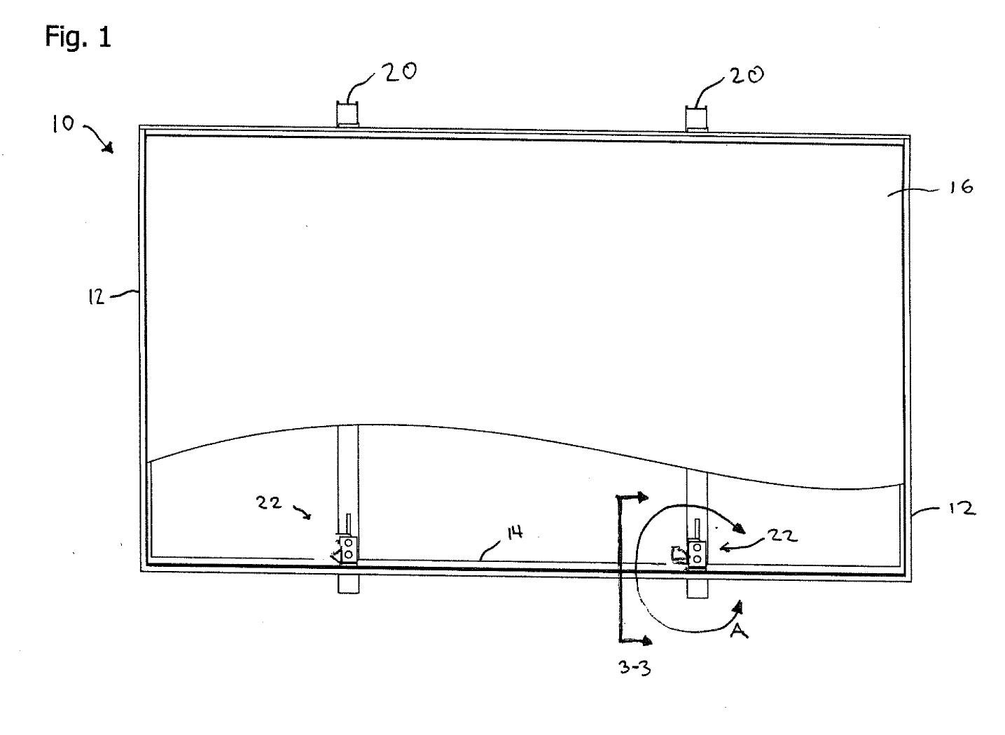

The present invention includes a mount mechanism for mounting a generally flat object to a supporting surface. In one embodiment, the generally flat object is a framed object. Preferably, the framed object is a solar panel. In one embodiment, the supporting surface is a rail—preferably elevated rail. With reference to FIG. 1, there is a solar panel 10 that has a frame 12 that surrounds the photovoltaic panel 16. The frame 12 has a flange 14 on the underside of the solar panel 10. The flange 14 is below the solar panel 10 so that is concealed from top view. The solar panel 10 is mounted on a pair of rails 20 or bars. The rails 20 are preferably elevated over the surface to which the solar panels are mounted. The rails 20 are typically attached to ballast boxes or trays or mounted on generally vertically extending posts that extend from ballast boxes or trays or are affixed directly to the underlying roof structure.

The present invention works best to secure a relatively flat surface such as a plate. In one embodiment, the object is a frame having a securable flange or lip. The flat surface has a thickness that is a minimum of about 4 mm, preferably about 3 mm, most preferably about 2 mm.

The rails 20 can be tubular, semi-tubular, round, square or other shape. Preferably the rails 20 are semi-tubular generally U-shaped rails having an opening at the bottom side of the rail. The top side of the rail 20 is substantially flat in one embodiment. The rails 20 may be positioned vertically, horizontally or on an angle. Preferably, the rails 20 are positioned horizontally or on a generally horizontal angle. By generally horizontal, it is meant at an angle that is less than 45 degrees from horizontal. Typically, solar panels are optimally positioned at a 30 degree angle when the panels can be adequately spaced apart from one panel to another. However, when space is at a premium, optimal conditions for generating electricity and space efficiency have the rails 20 placed on an angle ranging from 10 degrees from horizontal to 20 degrees from horizontal—typically 15 degrees from horizontal to minimize the space required between panels due to shadows cast from previous rows of solar panels. In one embodiment, an angle of 10 degrees is desirable to prevent damage due to high winds.

The rails 20 can be made of any durable and strong supportive material known in the art. Preferably, the rails 20 are made of steel or aluminum. Aluminum rails can be extruded. Steel rails are preferably coated with corrosion resistance coating such as a stainless steel coating, chromium steel coating, galvanized steel coating or a painted coating including powder coated steel. In one embodiment, the rails are made of fiberglass, wood, graphite, Kevlar® or composites including one or more of these materials thereof. In one preferred embodiment, the rails are made of wood.

In one embodiment, the rails 20 are steel and are made from a minimum of 20 gauge steel. Preferably, the steel is 18 gauge steel.

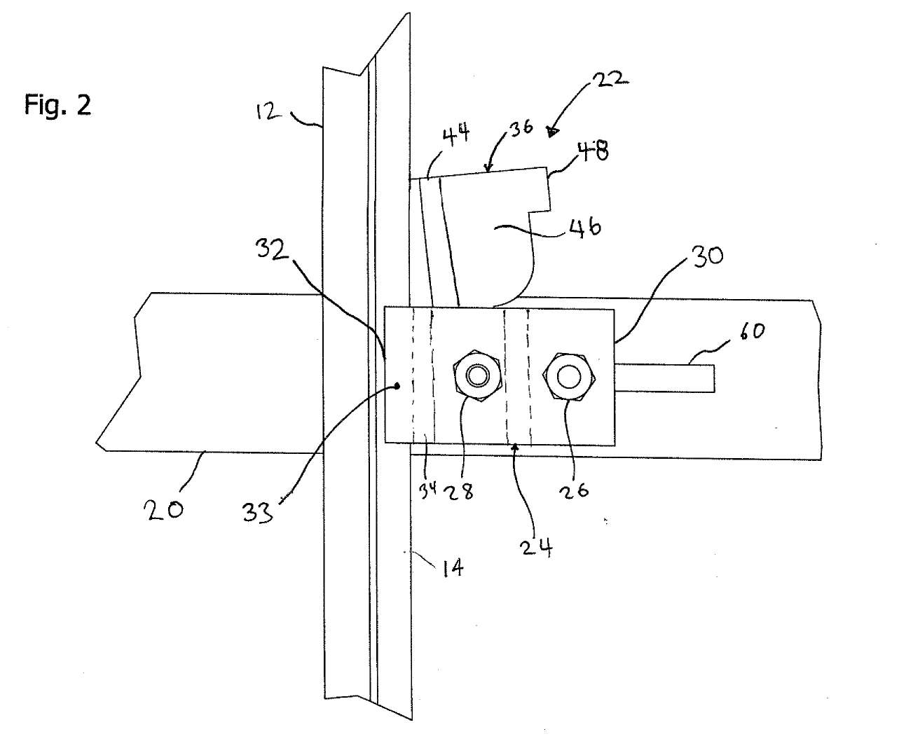

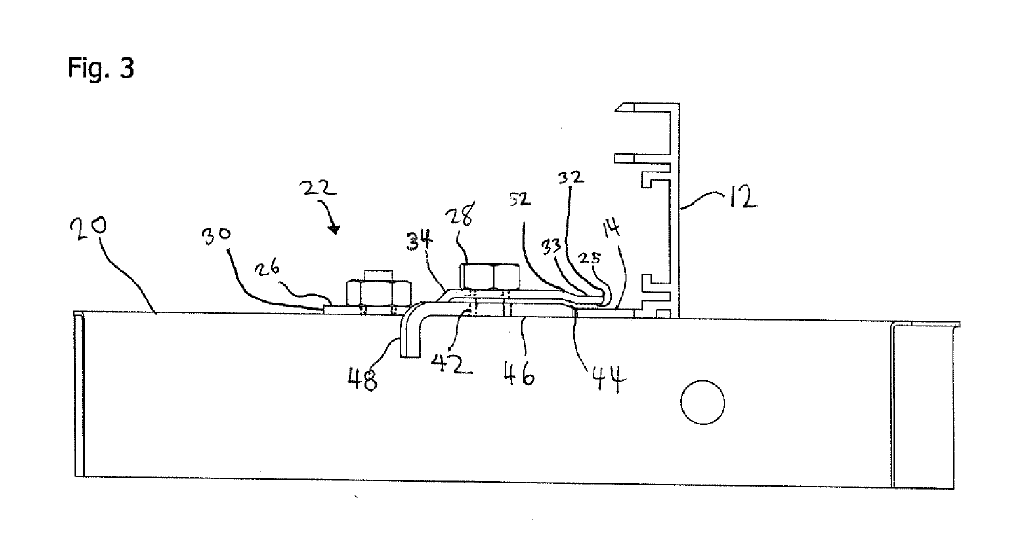

The rails 20 have one or more clamping mechanisms 22 attached to the rails. The clamping mechanisms 22 are described with reference to FIGS. 2 and 3 and continued reference to FIG. 1. FIG. 2 shows a top view of the clamping mechanism 22 of one embodiment. The clamping mechanism 22 comprises a generally elongated clamp plate 24 attached to the rail 20. The clamp plate 24, of one embodiment, is affixed to the rail 20 and has a first end 30 and a second end 32. The clamp plate 24 remains aligned with the rail 20, and it does not pivot relative to the rail 20. The clamp plate 24 is affixed to the rail by fasteners—preferably a pair of pins. By pins, it is meant generally cylindrical fasteners such as a pin, rod, nail, screw, bolt or rivet.

The clamp plate 24 is preferably made of steel having excellent flexural strength and elasticity. The clamp plate 24 of one embodiment is made of steel that is at least 18 gauge steel, preferably at least 16 gauge steel, more preferably 14 gauge steel. In one embodiment, the clamp plate 24 has a clamp pad 33 proximal to the second end 32 of the clamp plate 24. The clamp plate 24, of one embodiment, is formed with a textured surface 25 on the bottom such as a knurled surface, grooves or bumps to grip the top of the flange 14 of the frame 12 and improve the conductivity therebetween when the wedge plate is moved into a clamping position.

As shown in FIGS. 2 and 3, the pins (of one embodiment) are bolts 26 and 28 secured by a nut on the under side of the rail. The bolts 26 and 28 are slidably received in longitudinally extending channels so that the clamp plate 24 is slidably attached to the rail and the position of the clamp plate 24 can be longitudinally adjusted relative to the rail. Preferably, the bolts 26 and 28 and nuts are stainless steel or otherwise corrosion resistant. If a nut and bolt fastener is use, the nut of one embodiment is preferably a vinyl locking nut so that the effective distance between the head of the bolt and the nut can be predetermined in factory settings to avoid having to use a tool to tighten the nut and bolts 26 and 28. The first bolt 26 is located proximal to the first end 30 of the clamp plate 24. It secures the clamp plate 24 to the rail 20. A second longitudinally spaced apart bolt 28 is positioned medial to the first end 30 and the second end 32. A joggle bend 34 is positioned between the first nut 26 and the second 28 nut to form a gap that is, at a minimum, equal to the width of the wedge plate 36. A second joggle bend 52 is formed between the second end 32 and the second nut 28 and defines the clamp pad 32 and forms a generally bow shaped clamp plate 24 secured by the second nut 28 at the apex of the generally bow shaped clamp plate 24.

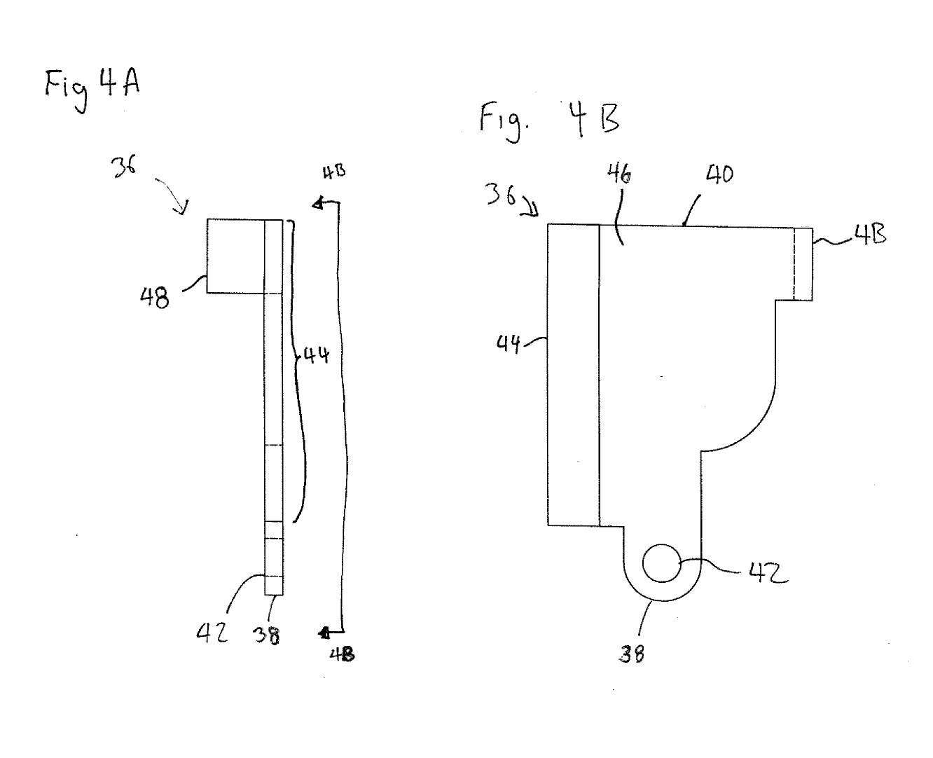

The wedge plate 36 is illustrated with reference to FIGS. 4A and 4B and with continued reference to FIGS. 2 and 3. The wedge plate 36 has a first end 38 and a second end 40. Proximal to the first end is a pivot hole 42 that is configured to pivotally receive a pin (including rivet or bolt). Proximal to the second end 40 of the wedge plate 36 is a wedge head 46. On one side of the wedge plate is formed a beveled edge 44. The wedge plate 36 is assembled into the clamping mechanism 22 so that the beveled edge 44 rotates toward the rail 20 to engage the clamping mechanism between the clamp plate 24 and the rail 20. On the opposite side to the beveled edge 44 is a thumb pad 48.

The wedge plate is preferably made of steel or aluminum. The steel wedge plate of one embodiment is made of steel that is at least 16 gauge steel, preferably at least 14 gauge steel, more preferably at least 12 gauge steel. In one preferred embodiment, the steel for the wedge plate is 11 gauge steel. In one embodiment the wedge head 46 is formed with a textured surface on the top such as a knurled surface, grooves or bumps to score the bottom of the flange 14 of the frame 12 and improve the conductivity therebetween. In one embodiment, the beveled surface is capable of scoring the flange 14 of the frame 12 and improving the electrical conductivity between the rail 20 and the frame 12.

The wedge plate 36 is pivotal from a disengaged position to a clamping position. The clamping position is the position of the wedge plate 36 where the wedge head 46 is between the clamp plate 24 and the rail 20. The disengaged position is any position that is not a clamping position.

In one embodiment, the solar panel 10 is mounted by the following procedure. The support surface of one embodiment is rails 20 placed in a generally horizontal position, preferably elevated. The rails have a clamping mechanism 22 on one side of the rail. The solar panel 10 is placed over the rails so that the clamping mechanism 22 is underneath the solar panel 10. The solar panel 10 is slid forward until the clamping mechanism engages the flange 14 on the frame 12 of the solar panel 10. A hand is reached underneath the solar panel. A thumb or finger is placed on the pad 48 of the wedge plate 36. The wedge plate 36 is positioned from a disengaged position to a clamping position by swinging the wedge plate 36 between the rail 20 and the clamping plate 22. Once the wedge plate 36 is positioned in a clamping position, the thumb pad 48 is designed so that it is relatively easy to press the wedge plate 36 into clamping position, but it is quite difficult to remove the wedge plate 36 from the clamping position. This is intended to deter theft of the solar panels 12 post installation.

When the wedge plate 36 is moved into clamping position, a clamping force is created between the clamp plate 24 and the rail 20 that is sufficiently strong to hold the solar panel 10 on the rail 20. The clamp plate 24 does not substantially fatigue over long periods of time due to its bow shaped and material with high strength and excellent shape-memory properties. Thus, the clamp plate 24 is believed to effectively hold the panels in place for several years without the need for tightening the bolts on the clamping mechanism, as is often needed in prior art mounting systems. The side of the solar panel opposite the clamp plate can be attached by a flange mechanism known in the art.

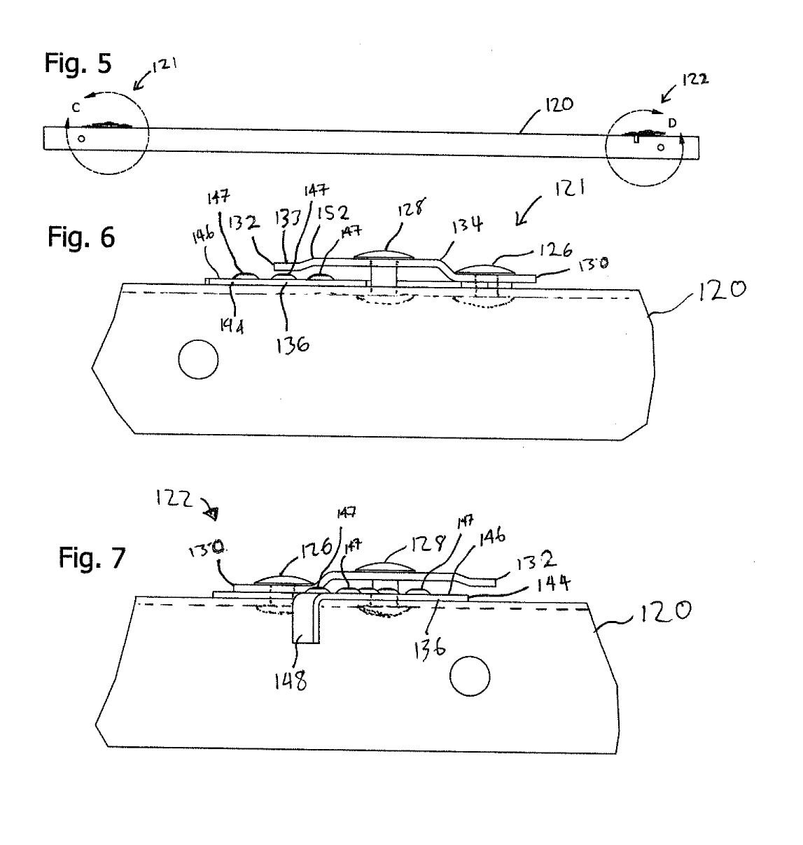

In one embodiment illustrated in FIG. 5, there is a rail 120 that has a pair of clamp mechanisms 121 and 122 attached to either end of the rail 120. At least one of the clamp mechanisms 121 and 122 are slidably attached to the rail 120 along a channel (not shown in FIGS. 5-7). The first clamp mechanism 121 is illustrated in FIG. 6 and the second clamp mechanism 122 is illustrated in FIG. 7.

With reference to FIGS. 6 and 7 and with continued reference to FIG. 5, the clamp mechanism 121 has a clamp plate 124 with a first end 130 and a second end 132. With like reference to FIG. 7 and continued reference to FIG. 5, the clamp mechanism 122 of FIG. 7 is the same as the clamp mechanism 121 of FIG. 6 except the clamp mechanism 121 of FIG. 6 is oriented in an opposite direction to the clamp mechanism 122 of FIG. 7. Thus, the two mechanisms will be described with like reference numbers at the same time.

The clamp plates 124 of the clamp mechanisms 121 and 122 are slidably attached to the rail 120 by a first rivet 126 and a second rivet 128 along a channel (not shown in FIGS. 5-7. The first rivet 126 is adjacent the first end 130 of the clamp plate 124. The clamp mechanisms 121 and 122 have a wedge plate 136 having a first end 138 and a second end 140. The wedge plate 136 is pivotally attached to the rail 120 by the first rivet 126. The wedge plate 136 is positioned between the clamp plate 124 and the rail 120.

The clamp plate 124 remains aligned with the rail 120 and does not pivot relative to the rail 120. The clamp plate 124 is preferably made of steel having excellent flexural strength and elasticity. The clamp plate 124 of one embodiment is made of steel that is at least 18 gauge steel, preferably at least 16 gauge steel, more preferably 14 gauge steel. In one embodiment, the clamp plate 124 has a clamp pad 133 proximal to the second end 132 of the clamp plate 124. The clamp plate 124 is formed with a textured surface on the bottom such as a knurled surface, grooves or bumps to grip the top of the flange 14 of the frame 12 and improve the conductivity therebetween when the wedge plate is moved into clamping position.

Preferably the rivets 126 and 128 are made of malleable steel and are coated with a corrosion resistant coating such as the various corrosion resistant coatings disclosed herein. The first rivet 126 is located proximal to the first end 130 of the clamp plate 124. It has an effective length between the rivet head and flanged end that is equal to the thickness of the clamp plate 124 plus the thickness of the wedge plate 136 and the thickness of the rail 120 with sufficient space that the wedge plate 136 freely pivots. It secures the clamp plate 124 to the rail 120. The second longitudinally spaced apart rivet 128 is positioned medial to the first rivet 126 and the second end 132. A first joggle bend 134 is positioned between the first rivet 126 and the second rivet 128. The first joggle elevates the portion of the clamp plate 124 adjacent the second rivet 128 relative to the first rivet 126. A second joggle bend 152 is positioned between the second rivet 128 and the second end 132 of the clamp plate 124 to form a generally bow shaped clamp plate 124 having a medially located apex 150. The second joggle bend 152 defines a relatively elevated apex 150 and a relatively lower clamp pad 133. The generally bow shaped clamp plate 124 having an apex 150 improves the performance of the clamp both in the short term and over years of use. The second rivet 128 defines a bend axis for the clamp plate. It is has been determined that the distance from the second rivet 128 to the second 132 of the clamp plate 124 should be less than 1.5 inches and preferably 1 inch. It has been likewise determined that the pivot axis of the wedge plate 136 is preferably attached to the first rivet 126 (proximate the first end 132 of the clamp plate). It is desirable for the wedge plate 136 to be positioned in the clamping position such that the flange 14 is sandwiched between the clamp plate 124 on the top of the flange 14 and the wedge plate 136 on the bottom side of the flange 14.

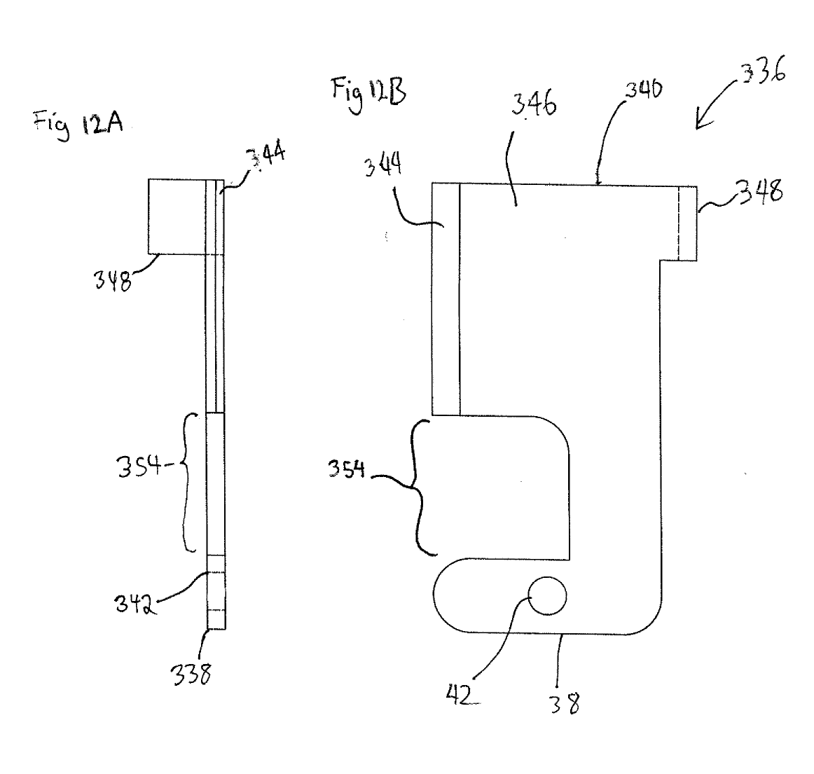

The wedge plate 136 is shown with reference to FIGS. 11A and 11B. The wedge plate 136 has a first end 138 and a second end 140. Proximal to the first end is a pivot hole 142 that is configured to pivotally receive the first rivet 126. Proximal to the second end 140 of the wedge plate 136 is a wedge head 146. On one side of the wedge plate 136 is formed a forward edge 144. The wedge plate 136 is assembled into the clamping mechanism 122 so that the forward edge 144 rotates toward the rail 120 to engage the clamping mechanism 122 between the clamp plate 124 and the rail 120. On the opposite side to the forward edge 144 is a thumb pad 148.

The wedge head 146 is formed with dimples 147 or bumps and on top of the bumps is a knurled surface to score the bottom of the flange 14 of the frame 12 and improve the conductivity therebetween. The forward edge of the wedge plate 136 need not be beveled as the dimples 147 are capable of scoring the flange 14 of the frame. Because the wedge plate 136 is affixed to the first rivet 126 adjacent the first end 130, a cut-away portion 154 is formed so that the wedge plate 136 conforms around the second rivet 128 when the wedge plate 136 is moved into a clamping position.

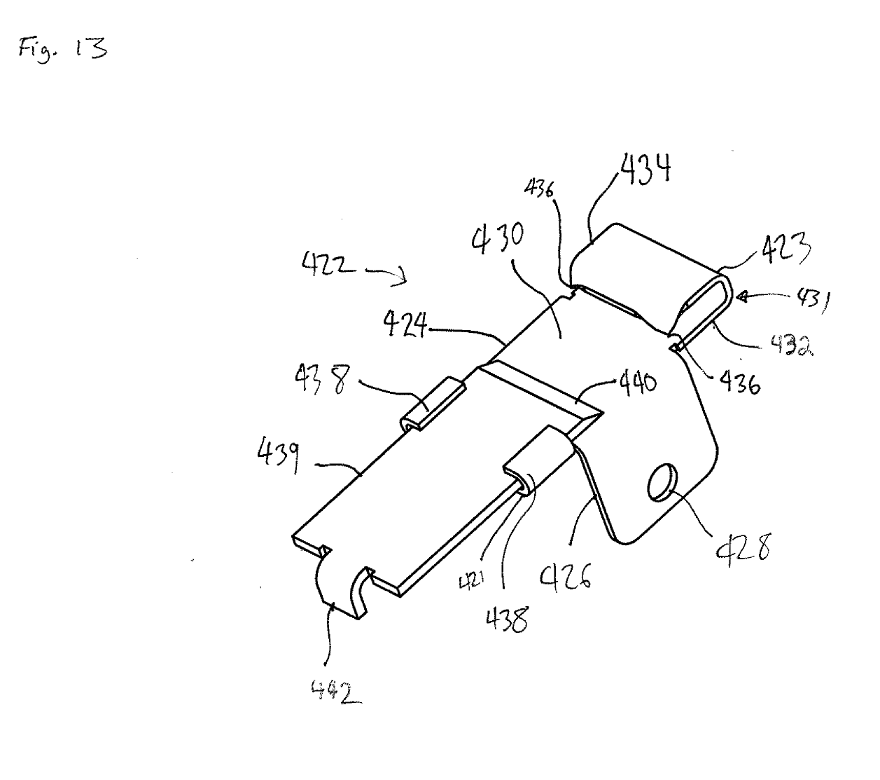

Another embodiment compatible with the system of FIGS. 5-7 is illustrated in FIGS. 12A and 12B by substituting the wedge plate 336 for wedge plate 136 in FIGS. 5-7. The wedge plate 336 is illustrated having a beveled forward edge 344 with no dimples. The forward edge 344 is capable of scoring the flange 14 of the frame 12 and improving the electrical conductivity between the rail 120 and the frame 12. Because the wedge plate 336 is affixed to the first rivet 126 adjacent the first end 330, a cut-away portion 354 is formed so that the wedge plate 336 conforms around the second rivet 128 when the wedge plate 336 is moved into a clamping position.

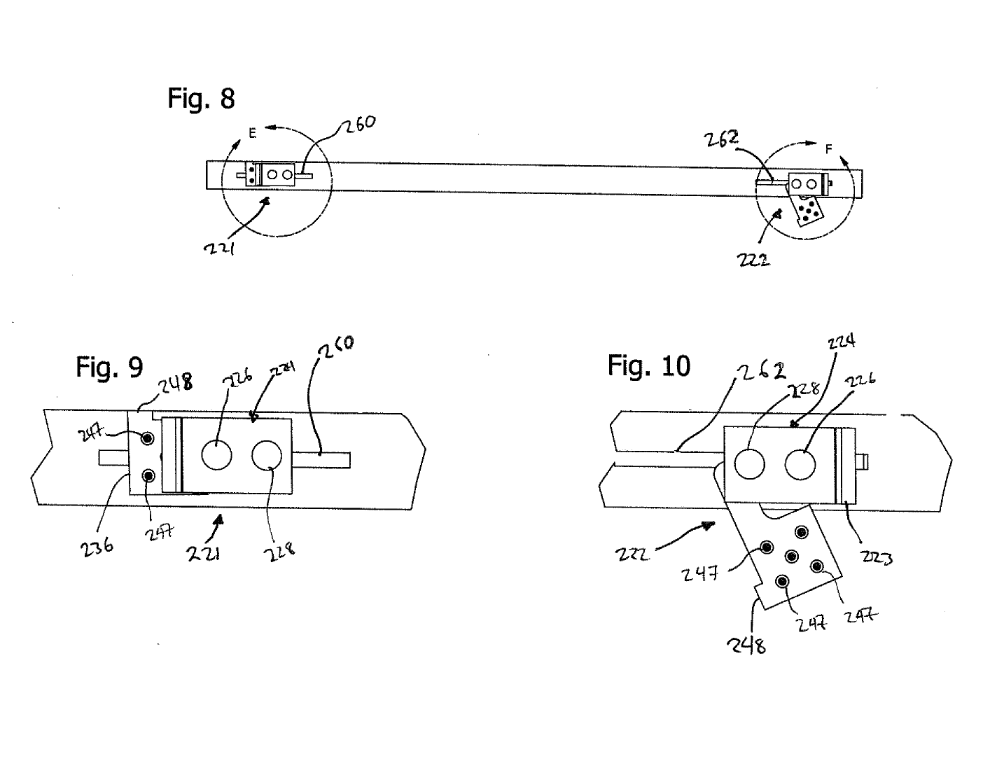

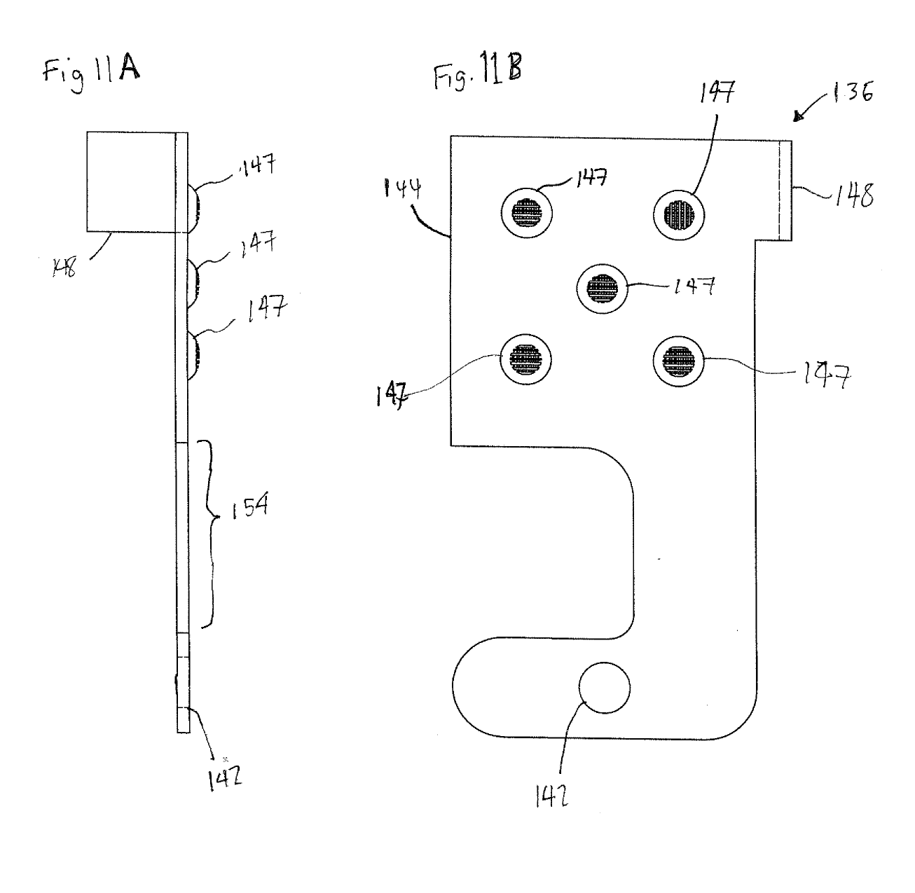

With reference to FIGS. 8-10, there is provided a rail 220 having a first clamp mechanism 221 and a second clamp mechanism 222 are slidably attached to channels 260 and 262 in rail 220. The first clamp mechanism 221 and second clamp mechanism 222 each have a clamp plate 224 and a wedge plate 236. The respective clamp plates 224 are slidably attached to the rail 220 along a channels 260 and 262 and are held into place by rivets having a predetermined distance between the rivet head and the rivet buck tail to ensure that the clamp has adequate clamping force to secure the solar panel frame 12 to the rail 220 but not to tight to prevent the movement of the clamp to a clamping position without the aid of tools such as a hammer, pliers, or fulcrum.

The wedge plate 236 is pivotal from a disengaged position to a clamping position. The clamping position is the position of the wedge plate 236 where the wedge head 246 is between the clamp pad 233 and the rail 220. The disengaged position is any position that is not a clamping position. The wedge plate 236 has a plurality of protrusions or dimples 247 that engage the flange 14 on the solar panel frame 12 to disrupt the annealing or coating and create an electrical connection between the clamp and the frame.

With continued reference to FIGS. 8-10, the solar panel 10 is mounted by the following procedure. The first clamping mechanism 221 and the second clamping mechanism 222 are slid along first channel 260 and second channel 262 towards the middle of the rail 220. The solar panel 10 is placed over the rails 220 so that the first clamping mechanism 221 and the second clamping mechanism 221 are underneath the solar panel 10. Once the solar panel is properly positioned on the rail, the first clamping mechanism 221 and the second clamping mechanism 222 are slid towards the frame 12 of the solar panel 10 until each of the clamping mechanisms 221 and 222 engage the flange 14 on the frame 12 of the solar panel 10. A hand is reached underneath the solar panel. A thumb or finger is placed on each of the pads 248 of the wedge plates 236 of each clamping mechanism 221 and 222. The wedge plate 236 is positioned from a disengaged position to a clamping position by swinging the wedge plate 236 between the rail 220 and the clamping plate 222.

When the wedge plate 236 is moved into clamping position, a clamping force is created between the clamp plate 224 and the rail 220 that is sufficiently strong to hold the solar panel 10 on the rail 220. The clamp plate 224 does not substantially fatigue over long periods of time. Thus, the clamp plate 224 is believed to effectively hold the panels in place for several years without the need for tightening the bolts on the clamping mechanisms 221 and 222, as is often needed in prior art mounting systems.

Depending upon the length of the channels 260 and 262, the channels allow movement of the clamp mechanisms 221 and 222 along the rail 220 to facilitate in one embodiment, the use of the solar panel mounting system with solar panels of varying sizes. However, because use of a single rail for different sizes of solar panels potentially creates less than optimal solar panel layout, the channels are useful to allow adjustments in the position of the panels responsive to mounting the system on uneven surfaces, such as roofs.

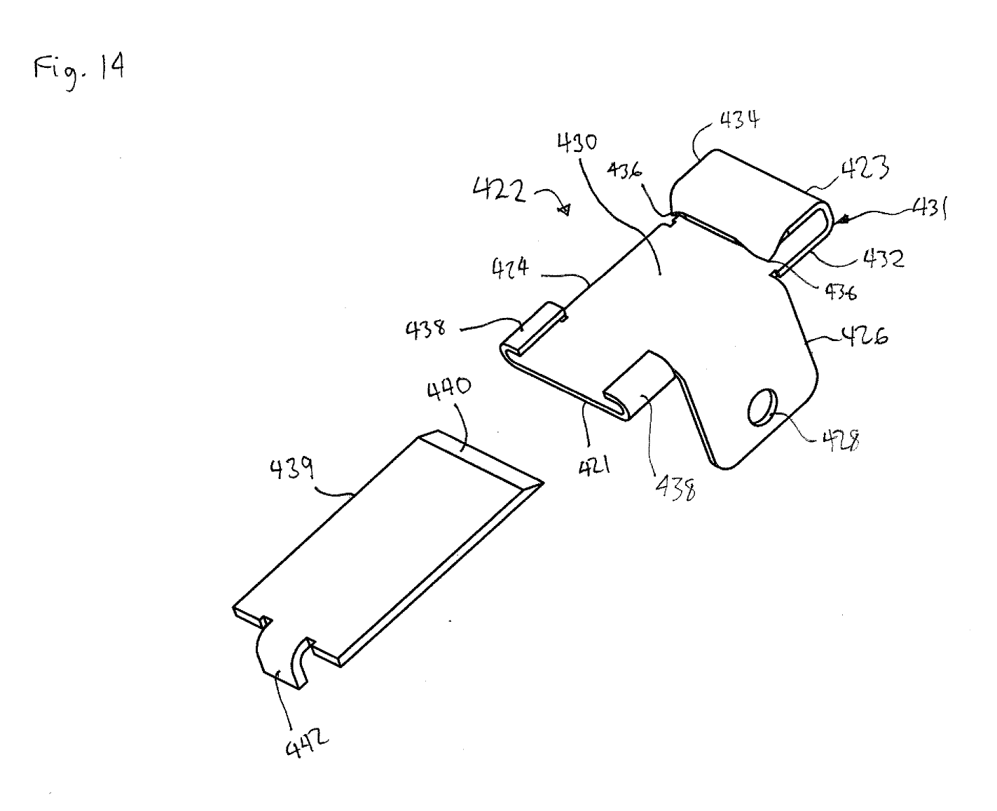

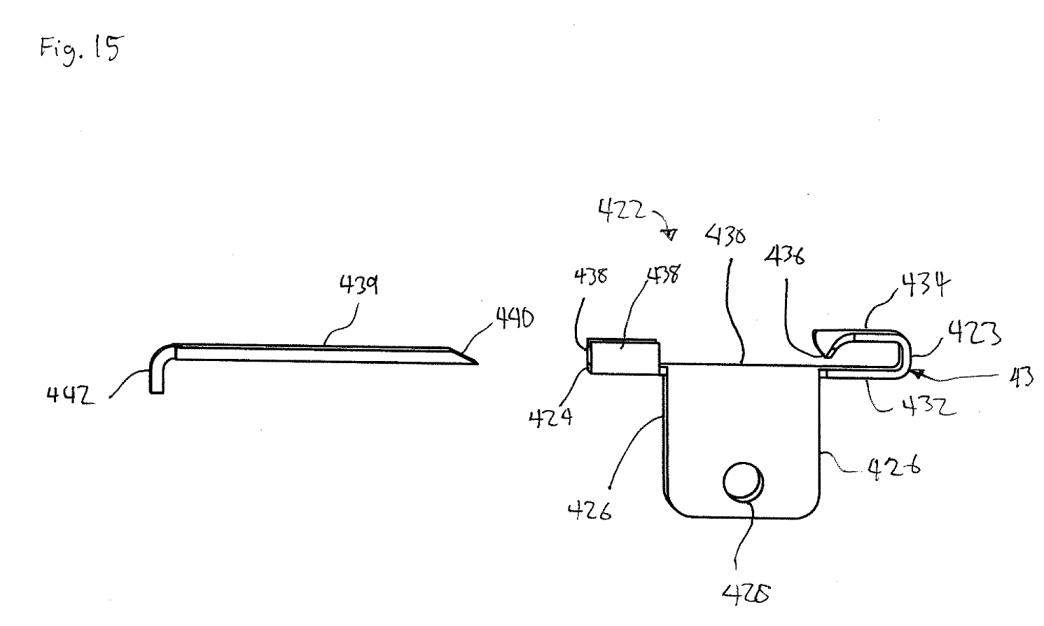

With reference to FIGS. 13-15, there is another embodiment of a wedge clamp mechanism 422. Wedge clamp mechanism 422 is configured to be mounted over the end of a rail 20. The wedge clamp 422 comprises a clamp base 424 having a first end 421 and a second end 423. The first end 421 comprises a pair of overturned flaps 438 defining a mouth 437 sized and configured to slidably receive a wedge plate 439. The wedge plate slides in a linear direction from the first end 421 of the clamp base 424 to the second end 423 of the clamp base 424. The second end 423 of the clamp base 424 forms a clamping jaw 431 having a clamp-jaw bottom 432 and a clamp-jaw top 434 having downward extending teeth 436. The flange 14 of the solar panel frame 12 fits into the clamp jaw 431. The wedge plate 439 is slid from a disengaged position to a clamping position where the beveled forward edge 440 of the clamp plate 439 is slid beneath the flange 14 into the clamp jaw 431 to clamp the flange within the jaw 431. Teeth 436 bear down on the upper surface of the flange to cause an electrically conductive connection between the frame and the clamp. The clamp mechanism 422 is secured to a rail by means of downwardly extending wings 426 that wrap around the sides of the rail. A pin fastener (not shown) including a nut and bolt or other fastener holds the wings to the sides of the rail.

What is claimed is:

1. A solar panel mount, comprising:
a base plate
a generally elongated clamp plate attached to the base plate proximal to a first end and having a clamp pad proximal to a second end; and
a wedge plate moveably connected to the base plate between the base plate and the generally elongated clamp plate, the wedge plate is movable from a first disengaged position to a second clamping position between the clamp plate and the base plate.

2. The mount of claim 1, wherein the mount is configured to support a solar panel having a clamp receiving flange that is clamped between the clamp pad and the base plate.

3. The mount of claim 1, wherein the base plate is a rail and the clamp plate and the wedge plate are slidably attached to rail by at least one pin that is slidable within a channel in the rail.

4. The mount of claim 1, wherein the base plate is generally bow shaped defining an apex having a predetermined height between the first end of the base plate and the second end of the base plate.

5. The mount of claim 1, wherein the clamp plate is generally bow shaped defining an apex having a predetermined height between the first end of the clamp plate and the clamp pad, the clamp plate is affixed proximal the first end by a first pin and a second pin proximal the apex.

6. The mount of claim 5, wherein the effective length of the first pin and second pin as well as the apex height are predetermined to create a distance between the clamp plate and the rail that is less than the thickness of the wedge plate.

7. The mount of claim 5, wherein the first pin and second pin are rivets having a predetermined distance between the head and buck tail of the rivet cooperating with the top plate and bottom plate to define clamp force therebetween that is sufficiently strong to hold the flange or flange in place but facilitates the movement of the wedge into a clamping position without need for tools.

8. The mount of claim 1, wherein the wedge plate has a bevel edge on the side that engages the rail and a thumb pad on the opposite side of the rail.

9. The mount of claim 1, wherein the wedge plate has a plurality of dimpled protrusions that are configured with a knurled surface to engage the flange.

10. The mount of claim 5, wherein the distance between the clamp plate and the rail creates a clamping force that enables the wedge plate to be pivoted into the clamping position manually, but is sufficiently strong to secure the plate to the rail.

9. A method of mounting a solar panel, comprising:
providing a solar panel of the type having a frame around the solar panel and a flange on the frame beneath the solar panel;
providing a solar panel mount of claim 1;
placing the flange between the clamp plate and the rail; and
moving the wedge plate from the disengaged position to the clamping position.

10. A method of mounting a solar panel, comprising:
providing a solar panel of the type having a frame around the solar panel and a flange on the frame beneath the solar panel;
providing a solar panel mount of claim 3;
sliding the clamp plate along the channel to position the clamp plate over the flange; and
moving the wedge plate from the disengaged position to the clamping position.

11. A framed object mount, comprising:
a supporting surface;
a generally elongated clamp plate attached to the surface proximal to a first end and having a clamp pad proximal to a second end; and
a wedge plate pivotally connected to the surface proximal to a first end of the wedge head between the surface and the generally elongated clamp plate, the wedge plate is pivotal from a disengage position to a clamping position that positions the wedge head between the clamp plate and the surface.

12. The mount of claim 11, wherein there is configured to support a framed object having a flange that is clamped between the clamp pad and the surface.

13. The mount of claim 11, wherein clamp plate and the wedge plate are slidably attached to surface by at least one pin that is slidable within a channel in the surface.

14. The mount of claim 11, wherein the clamp plate is generally bow shaped defining an apex having a predetermined height between the first end of the clamp plate and the clamp pad, the clamp plate is affixed proximal the first end by a first pin and a second pin proximal the apex.

15. The mount of claim 14, wherein the effective length of the first pin and second pin as well as the apex height are predetermined to create a distance between the clamp plate and the surface that is less than the wedge plate.

16. The mount of claim 14, wherein the first pin and second pin are rivets.

17. The mount of claim 11, wherein the wedge plate has a bevel edge on the side that engages the surface and a thumb pad on the opposite side of the surface.

18. The mount of claim 14, wherein the distance between the clamp plate and the surface creates a clamping force that enables the wedge plate to be pivoted into the clamping position manually, but is sufficiently strong to secure the plate to the surface.

19. A method of mounting a framed object, comprising:
providing a framed object of the type having a frame around the framed object and a flange on the frame beneath the framed object;
providing a framed object mount of claim 11;
placing the flange between the clamp plate and the surface; and
moving the wedge plate from the disengaged position to the clamping position.

20. A method of mounting a framed object, comprising:
providing a framed object of the type having a frame around the framed object and a flange on the frame beneath the framed object;
providing a framed object mount of claim 13;
sliding the clamp plate along the channel to position the clamp plate over the flange; and
moving the wedge plate from the disengaged position to the clamping position.
